(19) United States
(12) Patent Application Publication
(10) Pub. No.: US 2026/0067103 A1
(43) Pub. Date: Mar. 5, 2026

(54) METHOD AND SYSTEM FOR DYNAMIC REASSIGNMENT OF MASTER AND SLAVE NODES IN A LOCAL INTERCONNECT NETWORK (LIN)

(71) Applicant: Microchip Technology Incorporated, Chandler, AZ (US)

(72) Inventor: Paul Lepek, Northville, MI (US)

(21) Appl. No.: 19/318,021

(22) Filed: Sep. 3, 2025

Related U.S. Application Data
(60) Provisional application No. 63/690,129, filed on Sep. 3, 2024.

(51) Int. Cl. H04L 9/32; H04L 9/08; H04L 9/30

(52) U.S. Cl. CPC H04L 9/3271; H04L 9/0825; H04L 9/30

(57) ABSTRACT

Disclosed herein are apparatus, system, method, and computer-readable medium aspects for dynamically reassigning a master node in a Local Interconnect Network (LIN). An example method detecting a LIN frame comprising a master node modification request transmitted over a LIN bus. The method authenticates the master node modification request between a current master node and a slave node. The method also switches roles between the current master node and the slave node based on a successful authentication. The authentication operation can involve use of random number challenges and cryptographic keys. Additionally, firmware and hardware configurations can be modified in the method.

### CROSS-REFERENCE TO RELATED APPLICATION

The present application claims priority from U.S. Provisional Patent Application No. 63/690,129 filed Sep. 3, 2024, which is incorporated herein by reference in its entirety.

### TECHNICAL FIELD

The present disclosure relates generally to communication networks, and more specifically to a method and system for dynamic reassignment of master and slave nodes in a local interconnect network.

### SUMMARY

According to an aspect of one or more examples, there is provided a method for dynamic reassignment of a master node in a Local Interconnect Network (LIN). The method may include detecting a LIN frame comprising a master node modification request over a LIN bus, authenticating the master node modification request between a current master node and a slave node and switching roles between the current master node and the slave node based on a successful authentication.

The authentication operation may include sending to the slave node, from the current master node, a first random number (RND) challenge, generating a first digest response by the slave node using a slave private cryptographic key stored in a memory, receiving the first digest response from the slave node, validating the first digest response by encrypting the first RND challenge using a slave public cryptographic key stored in the memory to generate a first comparison digest response and comparing the first comparison digest response with the first digest response received from the slave node, and authenticating the slave node if the first comparison digest response matches the first digest response.

The authentication operation may include sending to the current master node, from the slave node, a second RND challenge, generating a second digest response by the current master node using a master private cryptographic key stored in the memory, receiving the second digest response from the current master node, validating the second digest response by encrypting the second RND challenge using a master public cryptographic key stored in the memory to generate a second comparison digest response and comparing the second comparison digest response with the second digest response received from the current master node, and authenticating the current master node if the second comparison digest response matches the second digest response.

The method may include modifying LIN firmware configurations through the LIN bus to facilitate the dynamic reassignment of the master node. The modification operation may include updating a first LIN software driver configuration on the current master node to reassign the role of the current master node to the slave node, updating a second LIN software driver configuration on the slave node to reassign the role of the slave node to the current master node, sending configuration commands over the LIN bus to update the LIN firmware configurations of the current master node and the slave node and executing the configuration commands to complete the dynamic reassignment operation of the master node. The method may include dynamically updating a schedule table of the LIN based on real-time monitoring of traffic patterns and network loading conditions, and adjusting time slot assignments and inter-frame spacing within the schedule table to control bandwidth utilization of the LIN bus and data transmission efficiency based on the roles of the current master node and slave node in the LIN.

The method may include adjusting LIN hardware configurations through the LIN bus. The adjustment operation may include modifying pull-up resistor settings to change electrical characteristics of the current master node and the slave node and updating microcontroller configurations to support the roles of the nodes. The method may include monitoring the LIN bus for errors and throughput limitations by the current master node and the slave node, and initiating the dynamic reassignment of the master node when a threshold for either the errors or the throughput limitations are reached.

According to an aspect of one or more examples, there is provided a system for dynamic reassignment of a master node in a LIN. The system may include a plurality of nodes including a current master node and a slave node, each node of the plurality of nodes connected to a LIN bus, a communication circuitry to transmit and receive LIN frames on the LIN bus, and a processing circuitry. The processing circuitry may identify a LIN frame including a master node modification request over the LIN bus, authenticate the master node modification request between the current master node and the slave node, and switch roles between the current master node and the slave node based on a successful authentication.

The system may include a memory to store a slave private cryptographic key, a master private cryptographic key, a slave public cryptographic key, and a master public cryptographic key. The processing circuitry may send a first RND challenge from the current master node to the slave node, generate a first digest response at the slave node using the slave private cryptographic key, receive the first digest response from the slave node, validate the first digest response by encrypting the first RND challenge using the slave public cryptographic key to generate a first comparison digest response and comparing the first comparison digest response with the first digest response received from the slave node, and authenticate the slave node if the first comparison digest response matches the first digest response. The processing circuitry may send a second RND challenge from the slave node to the current master node, generate a second digest response at the current master node using the master private cryptographic key, receive the second digest response from the current master node, validate the second digest response by encrypting the second RND challenge using the master public cryptographic key to generate a second comparison digest response and comparing the second comparison digest response with the second digest response received from the current master node, and authenticate the current master node if the second comparison digest response matches the first digest response.

The processing circuitry may modify LIN firmware configurations by updating a first LIN software driver configuration on the current master node to reassign the role of the current master node to the slave node, updating a second LIN software driver configuration on the slave node to reassign the role of the slave node to the current master node, sending configuration commands over the LIN bus to update the LIN firmware configurations of the current master node and the slave node, and executing the configuration commands to complete the dynamic reassignment operation of the master node. The processing circuitry may dynamically update a schedule table of the LIN based on real-time monitoring of traffic patterns and network loading conditions, and adjust time slot assignments and inter-frame spacing within the schedule table to control bandwidth utilization of the LIN bus and data transmission efficiency based on the roles of the current master node and slave node in the LIN.

The processing circuitry may adjust LIN hardware configurations through the LIN bus by modifying pull-up resistor settings to change electrical characteristics of the current master node and the slave node, and updating microcontroller configurations to support the roles of the nodes. The processing circuitry may monitor the LIN bus for errors and throughput limitations, and initiate the dynamic reassignment of the master node when a threshold for either the errors or the throughput limitations is reached.

According to an aspect of one or more examples, there is provided a computer-readable medium having instructions stored thereon that, when executed by at least one computing device, cause the at least one computing device to perform operations. The operations may include detecting a LIN frame comprising a master node modification request over a LIN bus, authenticating the master node modification request between a current master node and a slave node, and switching roles between the current master node and the slave node based on a successful authentication.

The authentication operation may include sending to the slave node, from the current master node, a first RND challenge, generating a first digest response by the slave node using a slave private cryptographic key stored in a memory, receiving the first digest response from the slave node, validating the first digest response by encrypting the first RND challenge using a slave public cryptographic key stored in the memory to generate a first comparison digest response and comparing the first comparison digest response with the first digest response received from the slave node, and authenticating the slave node if the first comparison digest response matches the first digest response.

The authentication operation may include sending to the current master node, from the slave node, a second RND challenge, generating a second digest response by the current master node using a master private cryptographic key stored in the memory, receiving the second digest response from the current master node, validating the second digest response by encrypting the second RND challenge using a master public cryptographic key stored in the memory to generate a second comparison digest response and comparing the second comparison digest response with the second digest response received from the current master node, and authenticating the current master node if the second comparison digest response matches the second digest response.

The operations may include adjusting LIN hardware configurations through the LIN bus. The adjustment operation may include modifying pull-up resistor settings to change electrical characteristics of the current master node and the slave node and updating microcontroller configurations to support the roles of the nodes. The operations may include monitoring the LIN bus for errors and throughput limitations by the current master node and the slave node, and initiating the dynamic reassignment of the master node when a threshold for either the errors or the throughput limitations are reached.

### BRIEF DESCRIPTION OF DRAWINGS

FIG. 1 shows a block diagram illustrating a system for dynamic reassignment of a master node in a Local Interconnect Network (LIN), according to one or more examples.

FIG. 2 shows a block diagram illustrating a LIN master-slave topology prior to dynamic reassignment, according to one or more examples.

FIG. 3 shows a block diagram illustrating a LIN master-slave topology after dynamic reassignment with switched roles, according to one or more examples.

FIG. 4 shows a flow diagram illustrating dynamic reassignment of master and slave roles in a LIN, according to one or more examples.

FIG. 5 shows a flowchart illustrating a method for dynamic reassignment of a slave node to a master node within a LIN, according to one or more examples.

FIG. 6 shows a flow diagram illustrating a firmware execution method within a LIN master node, according to one or more examples.

FIG. 7 shows a block diagram illustrating an authentication firmware execution method within a LIN master node, according to one or more examples.

FIG. 8 shows a block diagram illustrating a plurality of functional components of a firmware, according to one or more examples.

FIG. 9 shows a block diagram illustrating frame slots used in scheduling transmissions on a LIN, according to one or more examples.

FIG. 10 shows a block diagram illustrating a throughput measurement within a LIN by data publishing and subscribing operations, according to one or more examples.

FIG. 11 shows a block diagram illustrating a LIN having a master node and two slave nodes, according to one or more examples.

FIG. 12 shows a block diagram illustrating a dynamically reassigned and secured LIN, according to one or more examples.

FIG. 13 shows a block diagram illustrating a LIN Protected Identifier (PID) channel monitor, according to one or more examples.

FIG. 14 shows a block diagram illustrating a LIN Master Firmware Stack Model, according to one or more examples.

FIG. 15 shows a block diagram illustrating a LIN node with a high-speed (HS) interface, according to one or more examples.

FIG. 16 shows a block diagram illustrating a method for dynamic reassignment of a master node in a LIN, according to one or more examples.

### DETAILED DESCRIPTION OF VARIOUS EXAMPLES

Reference will now be made in detail to the following various examples, which are illustrated in the accompanying drawings, wherein like reference numerals refer to like elements throughout. The following examples may be embodied in various forms without being limited to the examples set forth herein.

Local Interconnect Network (LIN) serves as a standardized communication protocol widely adopted across various industries, particularly in automotive and industrial applications. LIN systems typically include a master node connected via a single data wire to multiple slave nodes, collectively forming a network cluster. The LIN master role is often permanently assigned to a single Electronic Control Unit (ECU), while slave roles are similarly fixed to their respective ECUs. These components function within a predefined role, where the master node may orchestrate communication across the LIN, directing data traffic to and from the slave nodes. The LIN system may pose significant limitations, particularly when network modifications or dynamic role reassignments are needed. For example, a lack of fault mitigation can occur if the master node fails, potentially leading to systemic failures or diminished network performance. Additionally, the static nature of the roles may prevent direct communication between slave nodes, restricting adaptability and responsiveness of the LIN system to operational changes. The inability of slave nodes to communicate directly without mediation of the master node may limit efficient network management, especially when the master node encounters bottlenecks that impair its capacity to manage traffic effectively. Therefore, there is a need for an improved method and system for dynamic reassignment of master and slave nodes in the LIN.

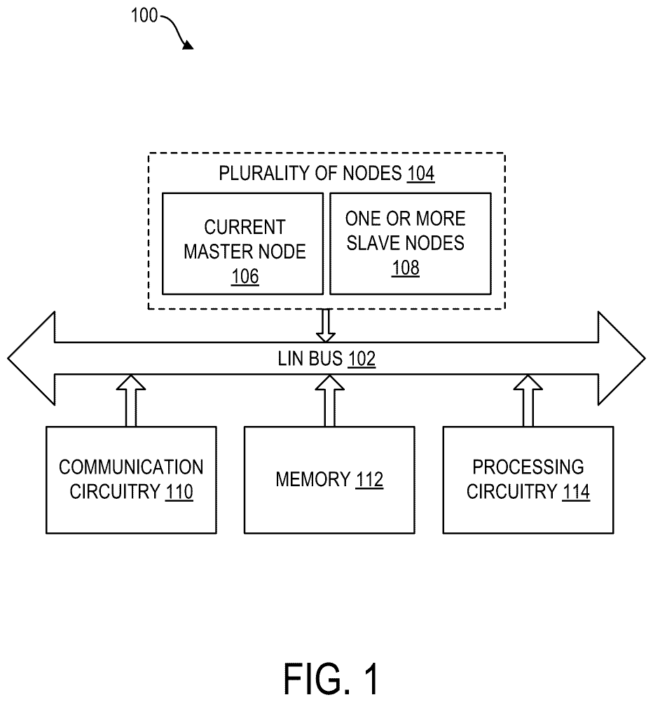

FIG. 1 shows a block diagram illustrating a system 100 for dynamic reassignment of a master node in a LIN, according to one or more examples. The system 100 may include a LIN bus 102, a plurality of nodes 104, a communication circuitry 110, a memory 112, and a processing circuitry 114. The plurality of nodes 104 may include a current master node 106 and one or more slave nodes 108. The LIN bus 102 may directly or indirectly couple components such as the plurality of nodes 104, the communication circuitry 110, the memory 112 and the processing circuitry 114. The LIN bus 102 may act as a physical layer through which data transmission and control commands are channeled within the system 100. The LIN bus 102 may facilitate propagation of a plurality of LIN frames across the LIN, to maintain communication reliability and integrity. In one or more examples, the LIN Bus 102 may facilitate propagation of one or more master node modification requests and one or more role-switching commands between the master and slave nodes. In one or more examples, the communication circuitry 110, the memory 112, and the processing circuitry 114 may be integral components of each node within the plurality of nodes 104, including the current master node 106 and the one or more slave nodes 108.

In an event when the processing circuitry 114 detects a LIN frame including a master node modification request, the processing circuitry 114 may leverage the LIN bus 102 to transfer the master node modification request across the LIN to an identified slave node of the one or more slave nodes 108. In one or more examples, a slave node of the one or more slave nodes 108 may be referred to as the identified slave node if the slave node detects one or more errors and throughput limitations or if the slave node receives a communication from the current master node 106 when the current master node 106 detects the one or more errors and throughput limitations. In response to a successful authentication, validated through cryptographic operations utilizing keys stored in the memory 112, the LIN bus 102 may facilitate transmission of configuration commands to enable the dynamic reassignment of roles between the current master node 106 and the identified slave node of the one or more slave nodes 108.

The plurality of nodes 104 may include the current master node 106 and the one or more slave nodes 108, each integrated within the system 100 to perform predefined roles according to operational dynamics of the LIN. The current master node 106 may act as a primary electronic control circuitry within the LIN, managing the transmission of the plurality of LIN frames across the LIN bus 102 to coordinate one or more activities of the one or more slave nodes 108. The current master node 106 may initiate, direct, and monitor communication flows within the LIN, thereby supporting operation and responsiveness of the system 100.

Each of the one or more slave nodes 108 may operate under control of the current master node 106, responding to commands and executing tasks as directed by the transmitted LIN frames. The one or more slave nodes 108 may perform a range of activities from sensor integrations to actuator controls, each assigned to the predefined roles within the system 100. In an event of a master node reassignment, the identified slave node of the one or more slave nodes 108 may be switched to the master node, taking over the communication and control responsibilities, such that the system 100 continues to operate seamlessly, adapting to shifts in operational dynamics or compensating for disruptions within the LIN when the current master node 106 is unable to perform its role.

The communication circuitry 110, used to secure data transmission within the system 100, may include a plurality of transceivers and interfaces adapted according to the LIN, to transmit and receive the plurality of LIN frames on the LIN bus 102. In one or more examples, the plurality of nodes 104 may include a transceiver of the communication circuitry 110, which is used to interface with the LIN bus 102 of the system 102. Similarly, the plurality of nodes 104 may include a high-speed bus interface of the communication circuitry 102, which may act as a gateway to broader networks, such as Ethernet or CAN bus systems, thereby extending range of the system 100 beyond the LIN.

The memory 112 may store a set of slave private cryptographic keys, a set of slave public cryptographic keys, a set of master private cryptographic keys, a set of master public cryptographic keys, a firmware, a set of LIN firmware configurations, a schedule table, and a set of LIN hardware configurations. The memory 112 may facilitate the dynamic reassignment operations and authentication protocols that secure communications across the LIN. The internal memory program or configuration image can be immutable, such that it can only be changed by an authenticated verified message from its peer communication node. The cryptographic keys in the memory 112 may be used during authentication operations, safeguarding integrity and confidentiality of data transfers across the LIN bus 102. The set of slave private cryptographic keys and the set of master private cryptographic keys may enable generation of digest responses during authentication, while the corresponding public cryptographic keys may be used for validating the digest responses, to secure role transitions and command execution within the LIN. The set of slave public cryptographic keys and the set of master public cryptographic keys, which may be computed based on the set of slave private cryptographic keys and the set of master private cryptographic keys, respectively, may be utilized to verify the digest responses. A secure boot functionality can be required to properly verify the digest responses. The set of slave private cryptographic keys, the set of slave public cryptographic keys, the set of master private cryptographic keys, and the set of master public cryptographic keys may each be securely stored during a provisioning operation using secure methods, including certificates, when asymmetric cryptography is used.

The set of LIN firmware configurations stored in the memory 112 may include a set of LIN software drivers that govern operation of the plurality of nodes 104. During a node role reassignment, the set of LIN software drivers within the set of LIN firmware configurations may be updated to transition the roles between the current master node 106 and the identified slave node of the one or more slave nodes 108, modifying operational firmware logic to enable the identified slave node to assume the role of the new master node, while the current master node 106 adapts the role of a new slave node. The firmware may manage the schedule table, which may determine a timing and priority of a plurality of LIN messages. The reassignment of the roles may prompt dynamic adjustments to the schedule table to align with the operational priorities of the new master node, for management of the plurality of LIN messages and node responsibilities within the LIN.

The set of LIN hardware configurations stored in the memory 112 may be associated with a plurality of adjustable parameters that govern physical and electrical properties of the plurality of nodes 104, facilitating dynamic role reassignments and operational adjustments. In one or more examples, the plurality of adjustable parameters may include settings such as pull-up resistor values, to adapt electrical characteristics of nodes during transitions between master and slave roles. In an event when the roles are switched between the current master node 106 and the identified slave node, microcontroller settings of a microcontroller of the nodes may be updated to support new roles, optimizing performance and compatibility in response to changes in network topology.

The processing circuitry 114 may manage and execute the dynamic reassignment of the master node within the system 100. The processing circuitry 114 may identify a LIN frame from the plurality of LIN frames which includes the master node modification request transmitted across the LIN bus 102. Upon identifying the LIN frame that includes the master node modification request, the processing circuitry 114 may authenticate the master node modification request to confirm that the master node modification request originates from an authorized node within the LIN.

The authentication of the master node modification request may include at least one of a master authentication process and a slave authentication process. In the master authentication process, the current master node 106, using the processing circuitry 114, may send a first random number (RND) challenge to the identified slave node. The identified slave node may receive the first RND challenge and generate a first digest response using the set of slave private cryptographic keys, stored in the memory 112. Subsequently, the identified slave node may send the first digest response back to the current master node 106. Upon receiving the first digest response, the current master node 106 may validate the first digest response by encrypting the first RND challenge using the set of slave public cryptographic keys stored in the memory 112 to generate a first comparison digest response and compare the first comparison digest response with the first digest response received from the identified slave node. A successful comparison may confirm authenticity of the identified slave node and secure the integrity of the authentication.

In the slave authentication process, the identified slave node, using the processing circuitry 114, may send a second RND challenge to the current master node 106. The current master node 106 may receive the second RND challenge and generate a second digest response using the set of master private cryptographic keys, stored in the memory 112. Subsequently, the current master node 106 may send the second digest response back to the identified slave node. Upon receiving the second digest response, the identified slave node may validate the second digest response by encrypting the second RND challenge using the set of master public cryptographic keys stored in the memory 112 to generate a second comparison digest response and compare the second comparison digest response with the first digest response received from the current master node 106. A successful verification may confirm authenticity of the current master node 106 and secure the integrity of the authentication.

To execute a role switch, the processing circuitry 114 may modify the LIN software driver configurations stored in the memory 112. In one or more examples, the processing circuitry 114 may update a first LIN software driver configuration on the current master node 106 to reassign its role to that of the identified slave node. Similarly, a second LIN software driver configuration on the identified slave node may be updated to assume the current master node 106. Following these updates, the processing circuitry 114 may send the configuration commands over the LIN bus 102 to implement the role changes across the system 100. The execution of the configuration commands may enable each node to adapt effectively to its new role.

The processing circuitry 114 may dynamically update the schedule table based on real-time traffic patterns and network loading conditions observed on the LIN bus 102. The processing circuitry 114 may adjust time slot assignments and inter-frame spacing to control bandwidth utilization and data transmission efficiency of the LIN, particularly based on the demands and capabilities of the new master node. The processing circuitry 114 may adjust the set of LIN hardware configurations by modifying pull-up resistor settings through the LIN bus 102. The modification may alter the electrical characteristics according to the new roles of the nodes, supporting their functionality as either master or slave.

The processing circuitry 114 may continuously monitor the LIN bus 102 for the one or more errors and the throughput limitations. If such conditions reach predefined thresholds, the processing circuitry 114 may initiate the dynamic reassignment of the master node, thereby maintaining integrity and operational continuity of the system 100 even under fluctuating network conditions or potential faults due to the one or more errors and throughput limitations.

The system 100 may dynamically respond to the fluctuating network conditions that demand a master-slave node swap or a firmware update. The fluctuating network conditions may include bandwidth limitations where a slave node is unable to transmit data to the current master node 106 at a predefined rate, and situations where the slave node cannot timely share its data with another slave node due to bandwidth constraints imposed by the current master node 106. Additionally, the system 100 may detect the faults within the current master node 106, including partial or total failures that disrupt proper LIN signal transmission to the one or more slave nodes 108. Upon detection of the fluctuating network conditions or the faults, the processing circuitry 114 may initiate corrective actions which may include a node swap or a reconfiguration of network parameters.

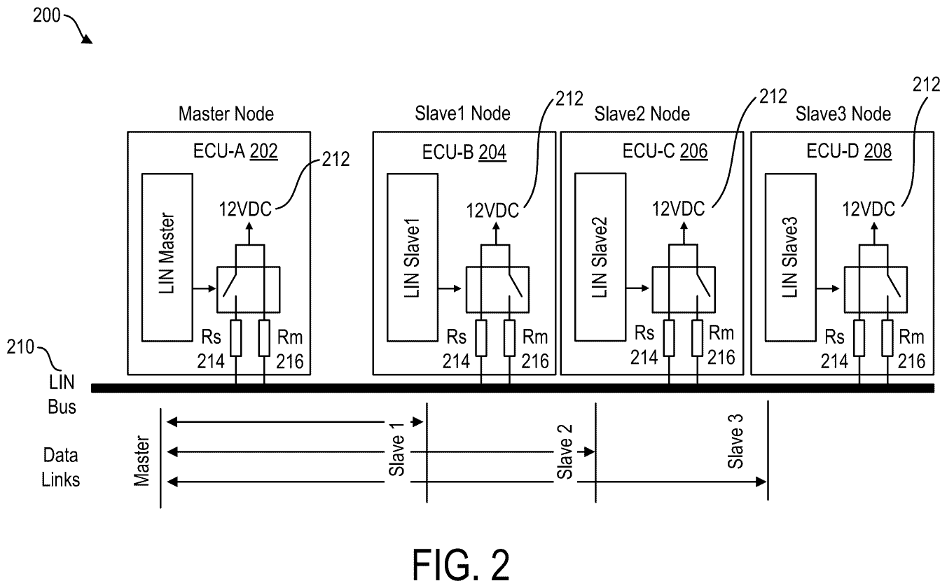

FIG. 2 shows a block diagram illustrating a LIN master-slave topology 200 prior to dynamic reassignment, according to one or more examples. The LIN master-slave topology 200 may include four ECUs, designated as ECU-A 202, ECU-B 204, ECU-C 206, and ECU-D 208. The ECU-A 202 may operate as the Master Node, directly interfacing with the LIN bus 210 to orchestrate communication across the LIN. The ECU-B 204, ECU-C 206, and ECU-D 208 may function as Slave Nodes 1, 2, and 3, respectively, each playing a role in data transmission and receiving instructions from the Master Node.

In one or more examples, each node in the LIN master-slave topology may be supplied with a 12-volt DC power source 212, to maintain stable operation and reliable communication. The LIN bus 210 may act as a foundational communication pathway, connecting all nodes through data links. The data links may be used for transmission of LIN frames, which carry command and control data between the master and slave nodes.

A circuitry of each node may include two types of resistors, labeled as Rs 214 and Rm 216. In this topology, ECU-A 202, functioning as the Master Node, may have its Master Resistor (Rm) 216 engaged. Conversely, Slave Nodes ECU-B 204, ECU-C 206, and ECU-D 208 may have their Slave Resistors (Rs) 214 engaged, which may stabilize voltage of the LIN bus 210 during data reception and maintain the slave nodes in a passive listening mode under control of the master node ECU-A 202. The resistors (Rs 214, Rm 216) may provide dynamic flexibility within the system. Each ECU may include both types of resistors, Rs 214 and Rm 216, to transition from slave to master roles, or vice versa, during a reassignment process, for example, due to node failures or operational demands.

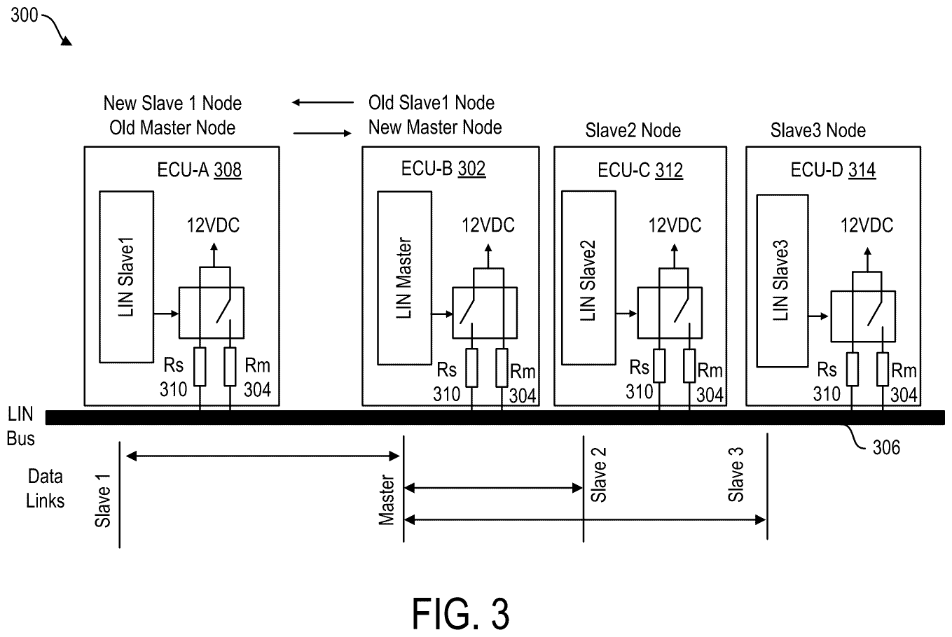

FIG. 3 shows a block diagram illustrating a LIN master-slave topology 300 after dynamic reassignment with switched roles, according to one or more examples. ECU-B 302, previously a slave node, may act as a new Master Node, utilizing its Master Resistor (Rm) 304 to control the LIN bus 306. The engagement of the Rm 304 in the ECU-B 302 may shift the role of ECU-A 308, which now serves as a new Slave 1 Node. The Slave Resistor (Rs) 310 of the ECU-A 308 may be engaged to facilitate passive mode operation. The updated topology may allow the ECU-A 308 to operate under the command of the new Master Node, ECU-B 302, to provide continuity in network operations despite node reassignments or disruptions.

ECU-C 312 and ECU-D 314 may continue to act as Slave Nodes 2 and 3, respectively. The Slave Resistors (Rs) 310 of the ECU-C 312 and the ECU-D 314 remain engaged, facilitating data reception and processing as directed by the ECU-B 302, now the new Master Node. The LIN master-slave topology 300 may allow continuous communication and operational efficiency across the LIN. The dynamic adjustment in the role of ECU-B 302 to the new Master Node and the subsequent engagement of the Rm 304 in the ECU-B 302 show flexibility of the system in network management.

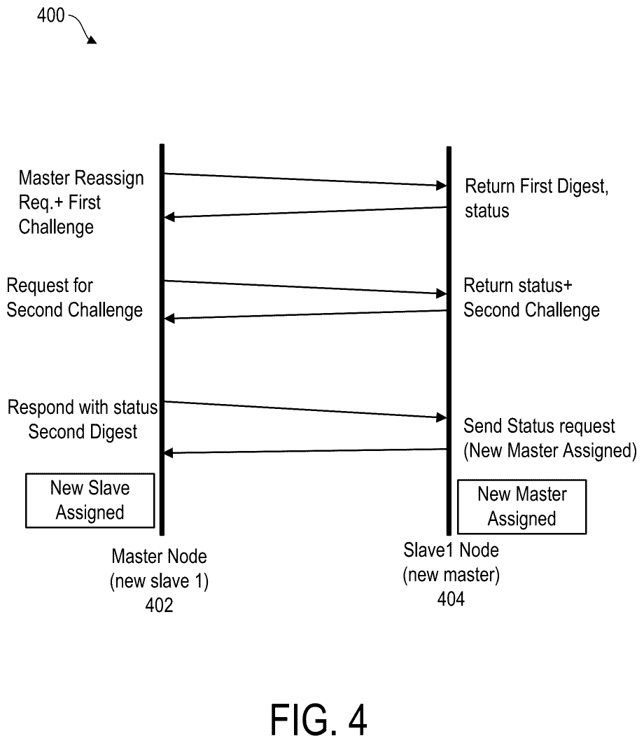

FIG. 4 shows a flow diagram 400 illustrating dynamic reassignment of master and slave roles in a LIN, according to one or more examples. The flow diagram details operations of transitioning the roles between two nodes, where an original master node 402 switches to a new slave node, and an identified slave node 404 switches to a new master node.

The operations may include sending a master node modification request (master reassignment request) along with a first RND challenge from the original master node 402 to the identified slave node 404. The first RND challenge may be sent to initiate the authentication operation between the nodes.

The identified slave node 404, upon receiving the master node modification request and the first RND challenge, may generate a first digest response using its set of slave private cryptographic keys stored in the memory 112. The identified slave node 404 may then send the first digest response back to the original master node 402.

The original master node 402 may receive the first digest response from the identified slave node 404. The original master node 402 may validate the first digest response by encrypting the first RND challenge using the set of slave public cryptographic keys stored in the memory 112 to generate a first comparison digest response and compare the first comparison digest response with the first digest response received from the identified slave node 404. A successful comparison may confirm authenticity of the identified slave node 404 for the new master node.

Following the successful authentication, the original master node 402 may send a request to the identified slave node 404 to send a second RND challenge to initiate a reverse authentication operation. The request may initiate the role transition process, beginning with an authentication operation where the identified slave node 404 verifies the original master node 402. The identified slave node 404, which is currently validated, may send the second RND challenge to the original master node 402.

The original master node 402, transitioning to the role of the new slave node, may generate a second digest response using its master private cryptographic keys stored in the memory 112. The original master node 402 may then send the second digest response back to the identified slave node 404.

The identified slave node 404 may receive the second digest response from the original master node 402. The identified slave node 404 may validate the second digest response by encrypting the second RND challenge using the set of master public cryptographic keys stored in the memory 112 to generate a second comparison digest response and compare the second comparison digest with the first digest response. A successful comparison may confirm the authenticity of the original master node 402 for the new slave node.

Upon successful verification, the identified slave node 404, now validated as the new master, may issue a status update command. The status update command may confirm the successful role reassignment, and signal that the identified slave node 404 is now functioning as the new master node within the system. The status update command may include sending a role confirmation along with operational parameters to the new slave node for synchronization across the LIN.

Simultaneously, the new master node may update its LIN software driver configuration to reflect the revised roles. The update may allow the new master node to manage the LIN bus. The updated LIN software driver configuration may include adjustments to operational parameters that synchronize network activity under supervision of the new master node. Similarly, the new slave node may update its LIN software driver configuration according to its role as a subordinate within the LIN.

The new master node and the new slave node may finalize their roles by updating Protected Identifier (PID) tables and cryptographic keys within their respective non-volatile memories. The new master node may set a Master_Role_bit to ‘true’, to confirm its authority within the LIN. Concurrently, the new slave node may set a Master_Role_bit to ‘false’, indicating its role as a subordinate within the LIN.

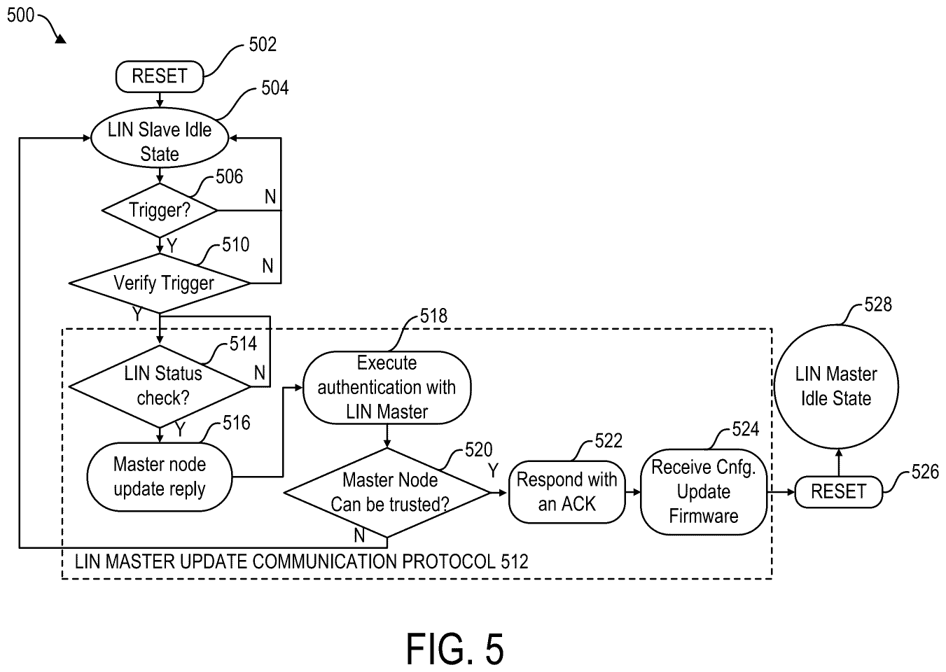

FIG. 5 shows a flowchart illustrating a method 500 for dynamic reassignment of a slave node to a master node within a LIN, according to one or more examples. It may be noted that in order to explain the method operations of the flowchart, references will be made to the elements explained in FIG. 1.

The flowchart starts with the system 100 in a reset state 502, where the current master node 106 and the one or more slave nodes 108 may reset to default LIN firmware and hardware configurations, to have a clear state to initiate the method operations. Following the reset, the identified slave node from the one or more slave nodes 108 may enter an idle state 504, ready to receive new instructions or triggers from the LIN. The method may include checking for a trigger 506 which is a predefined condition or request to update or reassign role within the LIN. If no trigger 506 is detected, the identified slave node may remain in the idle state 504, continuously monitoring for any new triggers.

Upon detection of the trigger 506, the system 100 may handle a LIN slave update request (may be referred as the master node modification request). The method may include verifying 510 the LIN slave update request to validate the trigger 506 to initiate switching of the roles and reassignment within the LIN.

In an event when the trigger 506 is verified at 510, the method may activate a LIN master update communication protocol 512, which includes assessing an operational status of the current master node 106 and the identified slave node via a LIN status check 514. The operational status may determine functional readiness of the current master node 106 and the identified slave node for switching of the roles. If the LIN status check 514 confirms that the operational status is favorable, the LIN master update communication protocol 512 may proceed to a master node update reply 516. The master node update reply 516 may indicate readiness of the current master node 106 to initiate role reassignment. If the LIN status check 514 finds that the operational status is unfavorable, the LIN master update communication protocol 512 may reinitiate LIN status check 514 until the operational status indicates functional readiness of the current master node 106 and the identified slave node for switching of the roles. Following the master node update reply 516, the method may include executing an authentication operation 518 with the current master node 106.

During the authentication operation 518, the identified slave node may verify trustworthiness 520 of the current master node 106. If the current master node 106 is authenticated successfully and deemed trustworthy, the current master node 106 may prompt the identified slave node to respond with an acknowledgment (ACK) 522. This response is only transmitted when the identified slave node authenticated the current master node 106 and the current master node 106 authenticated the identified slave node. The acknowledgment 522 may confirm the successful authentication and readiness of the identified slave node to proceed with the role transition.

However, if the current master node 106 fails the authentication operation 518 and cannot be trusted 520, the identified slave node may remain in the idle state 504 to maintain stability and security of the LIN. Upon receiving the acknowledgment 522 from the identified slave node, the method may include receiving configuration updates and firmware 524 for the identified slave node to assume the role of the new master node. The flowchart may terminate by resetting 526 the system 100, concluding the role switch. The new master node may assume control and transition into a LIN Master Idle State 528, ready to manage the LIN with the updated configurations.

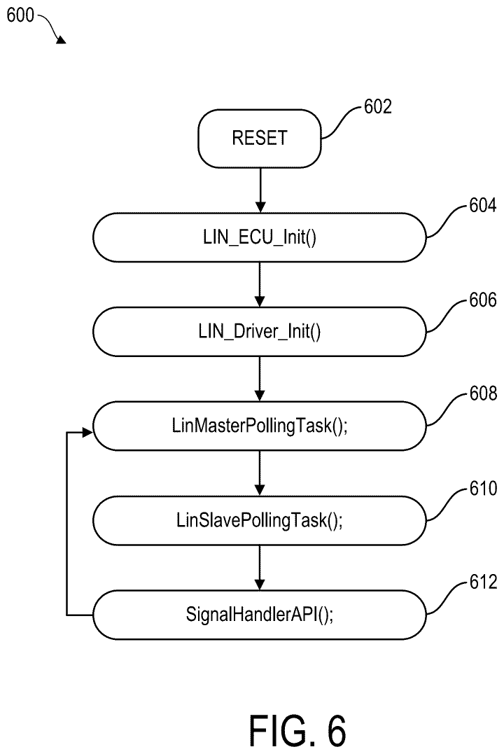

FIG. 6 shows a flow diagram illustrating a firmware execution method 600 within a LIN master node, according to one or more examples. The firmware execution method may include resetting 602 the LIN master node such that the LIN master node starts from a known state. Upon the reset 602, the firmware execution method may include initialization of ECU resources and reading configuration settings, denoted by LIN_ECU_Init( ) 604. Subsequently, the firmware execution method may include initializing LIN software drivers, denoted by LIN_Driver_Init( ) 606, which manages LIN master functionalities such as peripherals and nodes. Following the execution of the LIN_Driver_Init( ) 606, the firmware execution method may include transmission of LIN master frame data, denoted by LinMasterPollingTask( ) 608. The LinMasterPollingTask( ) 608 may send the LIN master frame data which includes a break signal, a synchronization byte, and a PID.

After the transmission of the LIN master frame data, the firmware execution method may include polling and managing the communications with the slave nodes within the LIN, denoted by LinSlavePollingTask( ) 610. The LinSlavePollingTask( ) 610 may enable the LIN master node to receive and process responses from the slave nodes effectively. During the LinSlavePollingTask( ) 610, the LIN master node may transmit and receive data payloads, along with checksums, to verify integrity of the data exchanged with the slave nodes. Subsequently, the firmware execution method may include executing SignalHandlerAPI( ) 612, which manages signal events and errors within the LIN. The firmware execution method may facilitate a continuous loop where, following the execution of the SignalHandlerAPI( ) 612, the firmware execution method loops back to the LinMasterPollingTask( ) 610, enabling the LIN master node to cyclically manage and monitor the LIN for ongoing communications and operational adjustments.

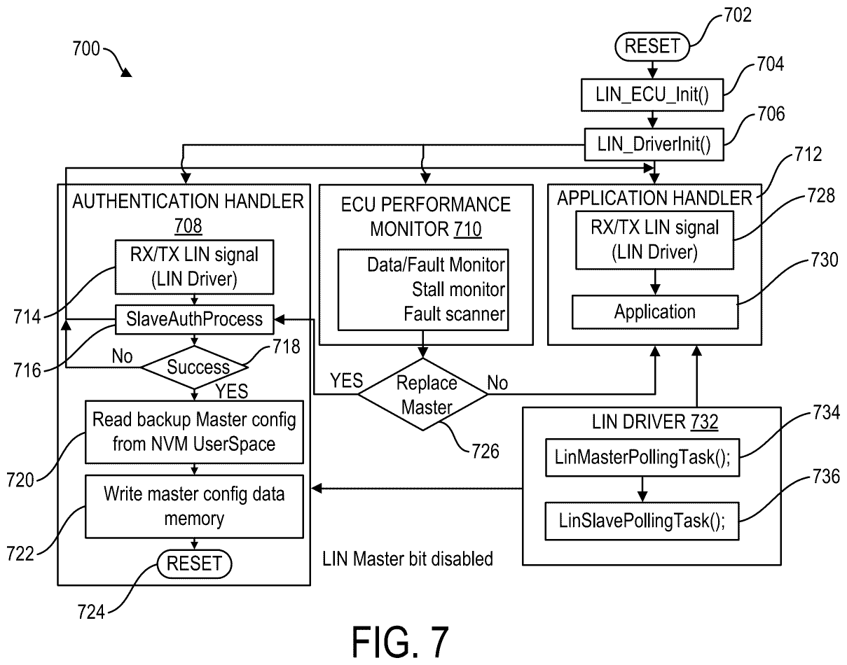

FIG. 7 shows a block diagram illustrating an authentication firmware execution method 700 within a LIN master node, according to one or more examples. The authentication firmware execution method 700 may include resetting 702 the LIN master node such that the LIN master node starts from a known state. Upon the reset 702, the authentication firmware execution method 700 may include initialization of ECU resources and reading configuration settings, denoted by LIN_ECU_Init( ) 704. Subsequently, the authentication firmware execution method may include initializing LIN software drivers, denoted by LIN_Driver_Init( ) 706, which manages LIN master functionalities such as peripherals and modes. Following the execution of the LIN_Driver_Init( ) 706, the authentication firmware execution method 700 may include operations for an authentication handler 708, operations of an ECU performance monitor 710, and operations of an application handler 712, for maintaining integrity and performance of the LIN master node.

The operations for the authentication handler 708 may include receiving RX/TX LIN signals 714 through a LIN driver 732 and performing a SlaveAuthProcess 716 to authenticate the identified slave node. If the authentication is unsuccessful, the operations for the authentication handler may include triggering the application handler 712. Upon a successful authentication 718, the operations for the authentication handler 708 may include reading a backup master configuration from a non-volatile memory (NVM) user space 720 and writing master configuration 722 in a memory of the LIN master node, where a LIN master bit is disabled and a LIN slave bit is enabled for the LIN master node, followed by resetting 724 the LIN master node.

The operations of the ECU performance monitor 710 may include continuously monitoring the data and fault status within the LIN. The ECU performance monitor 710 may include a stall monitor and a fault scanner, which assess performance of the system and detect any faults. The ECU performance monitor 710 may determine whether to replace the LIN master node or not. If the determination is to replace the LIN master node 726, the operations of the ECU performance monitor 710 may include triggering the authentication handler 708 to perform the SlaveAuthProcess 716 to verify the authentication of the identified slave node. If the determination is to not replace the LIN master node 726, the operations of the ECU performance monitor 710 may include triggering the application handler 712.

The operations of the application handler 712 may include receiving the RX/TX LIN signals 728 through the LIN driver 732. The application handler 712 may execute applications 730 based on the authenticated LIN signals. The LIN driver 732 may perform tasks such as LinMasterPollingTask( ) 734 and LinSlavePollingTask( ) 736. These tasks may include transmitting LIN master frame data, including Break, Sync, PID, payload, and checksum information. The authentication firmware execution method may enable the LIN master node to operate securely and efficiently while maintaining communication integrity with the LIN slave nodes and providing dynamic response capabilities to any detected faults or performance issues within the LIN.

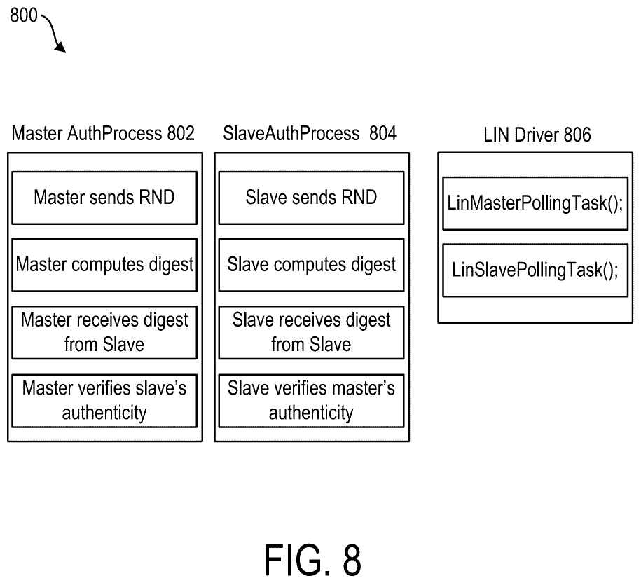

FIG. 8 shows a block diagram illustrating a plurality of functional components of a firmware 800, according to one or more examples. The plurality of functional components of the firmware 800 may include a MasterAuthProcess 802, a SlaveAuthProcess 804, and a LIN Driver 806. In the LIN, the current master node 106 and the one or more slave nodes 108 may monitor and scan the LIN bus 102 for the one or more errors and the throughput limitations. In an event when a threshold for either the errors or the throughput limitations is reached, the functionality of the current master node 106 can be switched to the functionality of a slave node and one of the current slave nodes 108 can be assigned the functionality of the LIN master node by initiating an authentication protocol to facilitate switching of the roles. Also, individual LIN slave node configurations can be updated, where for example a temperature sensor would only respond with a valid data when the temperature limit is reached, or can be taken offline if this function is no longer needed. On the contrary, an idle LIN slave node that is active (i.e., it could be addressed by the LIN master node) can be enabled for temperature reporting remotely. The bandwidth of addressing such LIN slave node can be controlled by the master node by simply enabling certain node features remotely either as a permanent or temporary node function. A slave node's functionality can also be reassigned to another slave node when the original slave node exceeds (e.g., creates a data bottleneck on a bus) an error or throughput limitation threshold. Additional slave nodes can also be added to a LIN system on the request of an authorization or a request of a LIN master node or a privileged node.

If the current master node 106 initiates the authentication protocol, the MasterAuthProcess 802 of the firmware may be activated prior to the SlaveAuthProcess 804. The MasterAuthProcess 802 may enable the current master node 106 to initiate authentication of the identified slave node by sending a first RND challenge to the identified slave node, computing a first comparison digest response based on the first RND challenge, receiving a first digest response from the identified slave node based on the first RND challenge and comparing the first digest response from the identified slave node with the first comparison digest response to confirm authenticity of the identified slave node.

Alternatively, if the identified slave node initiates the authentication protocol, the SlaveAuthProcess 804 of the firmware may be activated prior to the MasterAuthProcess 802. The SlaveAuthProcess 804 may enable the identified slave node to authenticate the current master node 106 by sending a second RND challenge to the current master node 106, computing a second comparison digest response based on the second RND challenge, receiving a second digest response from the current master node 106 based on the second RND challenge, and comparing the second digest response from the current master node 106 with the second comparison digest response to confirm the authenticity of the current master node 106. To summarize, the authentication process is applicable to the slave node as well as to the master node before any new LIN master node re-assignment is to take place. In other words, the identified slave node must authenticate the current master node and the current master node must authenticate the identified slave node for the LIN master node re-assignment to initiate.

The execution of the MasterAuthProcess 802 and the SlaveAuthProcess 804 may provide mutual authentication between the current master node 106 and the identified slave node, enabling the current master node 106 and the identified slave node to securely switch the roles and continue network operations of the system 100. The LIN Driver 806 of the firmware may perform tasks such as LinMasterPollingTask( ) and LinSlavePollingTask( ) These tasks may include transmitting LIN master frame data, including Break, Sync, PID, payload, and checksum information.

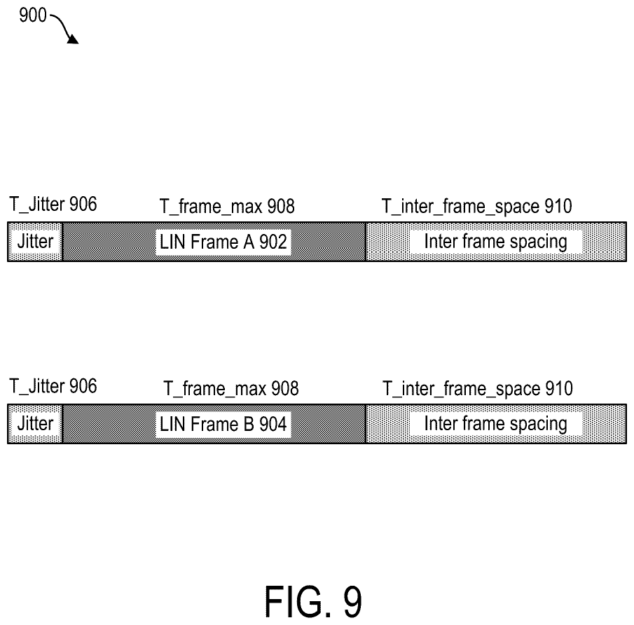

FIG. 9 shows a block diagram illustrating frame slots 900 used in scheduling transmissions on a LIN, according to one or more examples. The block diagram includes two frame slots, labeled as LIN Frame_A 902 and LIN Frame_B 904, each depicting timing components for organizing data transmissions within the LIN.

Each frame slot may include three timing components: T_{Jitter} 906, T_{frame_max} 908 and T_{inter_frame_space} 910. The T_{Jitter} 906 may compensate for variability in transmission timing due to network conditions and processing delays such that minor deviations do not disrupt scheduled communication. The T_{frame_max} 908 may represent maximum duration allowed for transmitting a LIN frame such that each frame fits within its allocated slot to prevent overlap. The T_{inter_frame_space} 910 may provide a time interval between end of one frame and start of next frame. The frame slots 900 may adapt to varying network conditions such as the errors and the throughput limitations to accommodate the dynamic node reassignment within the LIN. By defining each frame slot as a multiple of a base time constant T_{base}, where T_{frame_slot}=T_{base}×n, the system 100 may dynamically modify the schedule table, where n is a multiplier determining the timing for each frame.

The dynamic node reassignment and the modification of the schedule table may enable the system 100 to manage increased data traffic, network loading conditions and processing conditions. By adjusting the T_{frame_slot} and the T_{inter_frame_space} 910 dynamically, the system 100 may allocate additional bandwidth to areas with higher data transmission demands. The system 100 may dynamically adjust the T_{frame_max} 908 to extend or reduce the frame duration based on the data transmission demands. Additionally, the T_{inter_frame_space} 910 may be modified to provide more or less time between frames, depending on the processing conditions of the nodes. By implementing the dynamic adjustments to the T_{frame_slot} and the schedule table, the system 100 may respond to varying network conditions.

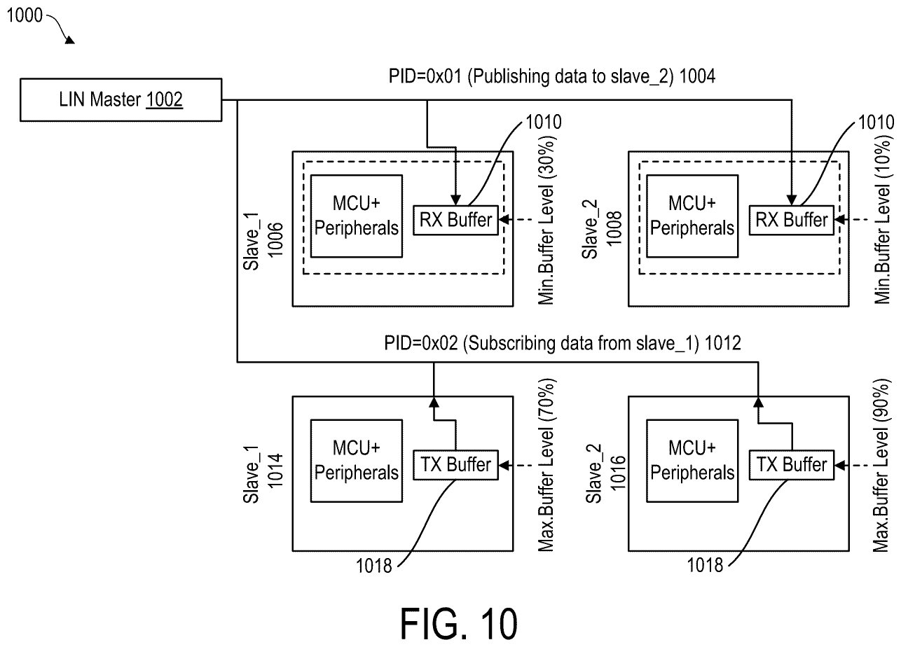

FIG. 10 shows a block diagram 1000 illustrating a throughput measurement within a LIN by data publishing and subscribing operations, according to one or more examples. The block diagram 1000 details interactions between a LIN master node 1002 and multiple slave nodes, specifically focusing on how the throughput measurement is performed using preconfigured PIDs.

In one or more examples, the LIN master node may publish data using a first PID (0x01) 1004 to Slave_1 1006 and Slave_2 1008. The first PID 1004 may be a part of the schedule table used to coordinate data transmission within the LIN, allowing the LIN master node to send identical payload application data to Slave_1 1006 and Slave_2 1008 simultaneously.

Each slave node, the Slave_1 1006 and the Slave_2 1008, may include an RX buffer 1010 to store incoming data. The RX buffer 1010 of the Slave_1 1006 may be set to a minimum buffer level threshold of about 30%, whereas the RX buffer 1010 of the Slave_2 1008 may be set to a minimum buffer level threshold of about 10%. If the RX buffer 1010 reaches its minimum buffer level threshold, an error or fault condition may be triggered, signaling a data underflow event. The data underflow event may be accumulated. The accumulation of the data underflow event to a predetermined error count may be indicative of a data bottleneck. If the predetermined error count is reached, the slave node may request the LIN master node 1002 to dynamically update its PID priority list and the schedule table or request for switching the roles with the LIN master node 1002.

In one or more alternative examples, the LIN master node 1002 may subscribe to the data from Slave_1 1014 and Slave_2 1016 using a second PID (0x02) 1012. Each slave node, the Slave_1 1014 and the Slave_2 1016, may include a TX buffer 1018 to manage the data to be sent to the LIN master node 1002. The TX buffer 1018 of the Slave_1 1014 may be set to a maximum buffer level threshold of about 70% or a buffer capacity level N_buf_tx1 predefined by the network, whereas the TX buffer 1018 of the Slave_2 1016 may be set to a maximum buffer level threshold of about 90% or N_buf_tx2, where N_buf_tx1 is less than N_buf_tx2. If the TX buffer 1018 exceeds its maximum buffer level threshold, the error or fault condition may be triggered, indicating a data overflow event. The data overflow event may arise when the LIN master node 1002 cannot retrieve data from the slave nodes at a predefined rate. If the data overflow event persists, the Slave_1 1014 may request the LIN master node 1002 to increase its PID priority or modify the schedule table to allocate more bandwidth. In an event where adjusting the PID priorities and the schedule table are insufficient to resolve the data underflow event and the data overflow event, the slave node may request to assume the role of the LIN master node 1002 if it can support a LIN Master configuration and supports its communication with the rest of the LIN bus providing it with a LIN muster node data interface.

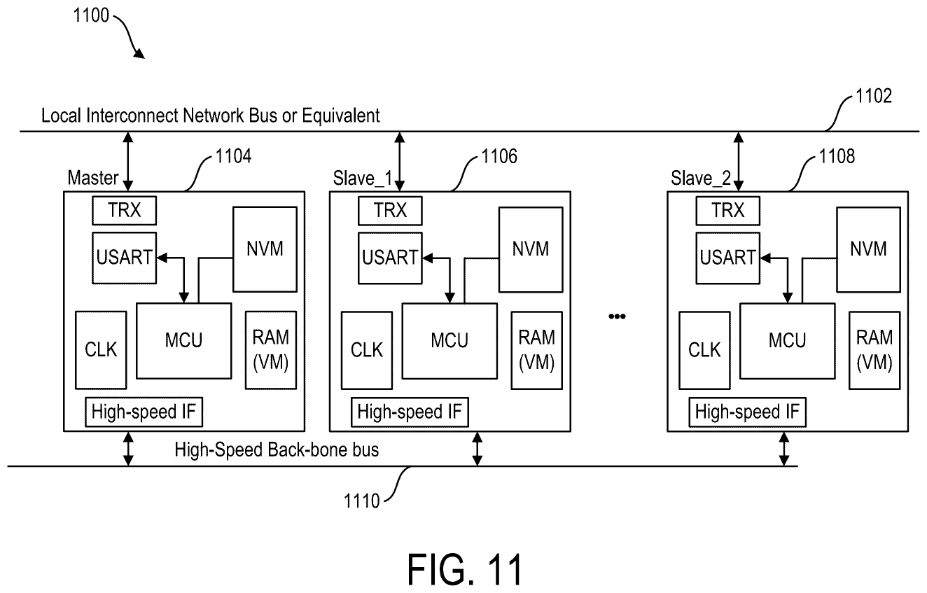

FIG. 11 shows a block diagram illustrating a LIN 1100 having a master node and two slave nodes, according to one or more examples. The LIN 1100 may include a LIN bus 1102 that connects the master node and the slave nodes, facilitating communication and data exchange across the LIN.

The master node 1104, labeled as “Master,” may include a microcontroller unit (MCU), a clock (CLK), a Universal Synchronous/Asynchronous Receiver/Transmitter (USART), a transceiver (TRX), a non-volatile memory (NVM), a random-access memory (RAM) allocated to a virtual machine (VM), and a high-speed interface (IF) to a high-speed backbone bus. The MCU may act as a central processing circuitry, executing control algorithms and managing data flow. The CLK may enable the master node to time operations. The USART may facilitate a serial communication with the slave nodes via the LIN bus, while the TRX manages electrical signals required for communication. The NVM may store configuration and control data, while the RAM provides temporary storage for dynamic operations. The high-speed IF may enable rapid data transfer to and from a high-speed backbone bus.

The slave nodes, labeled as “Slave_1” 1106 and “Slave_2” 1108, may include components similar to those in the master node to support their roles within the LIN. The slave nodes may include a MCU, a CLK, a USART, a TRX, a NVM, a RAM allocated to a VM, and a high-speed IF for communication with a high-speed backbone bus.

The MCU in a slave node may execute tasks as directed by the master node, handling data processing and task execution. The CLK in a slave node may facilitate synchronizing the operations with the master node and other components of the LIN. The USART may facilitate serial communication between each slave node and the master node via the LIN bus, allowing the slave nodes to receive and respond to commands. The LIN bus, labeled as the “Local Interconnect Network Bus or Equivalent,” may act as a primary communication pathway connecting the master node and the slave nodes. The LIN bus may enable propagation of LIN frames, which carry control commands and data between the nodes.

The high-speed backbone bus 1110, connected via the high-speed IFs in each node, may provide an additional layer of connectivity for events to facilitate rapid data transfer. The high-speed backbone bus 1110 may enable the LIN to interface with broader networks and handle more complex data-intensive tasks, enhancing the overall performance and flexibility of the network.

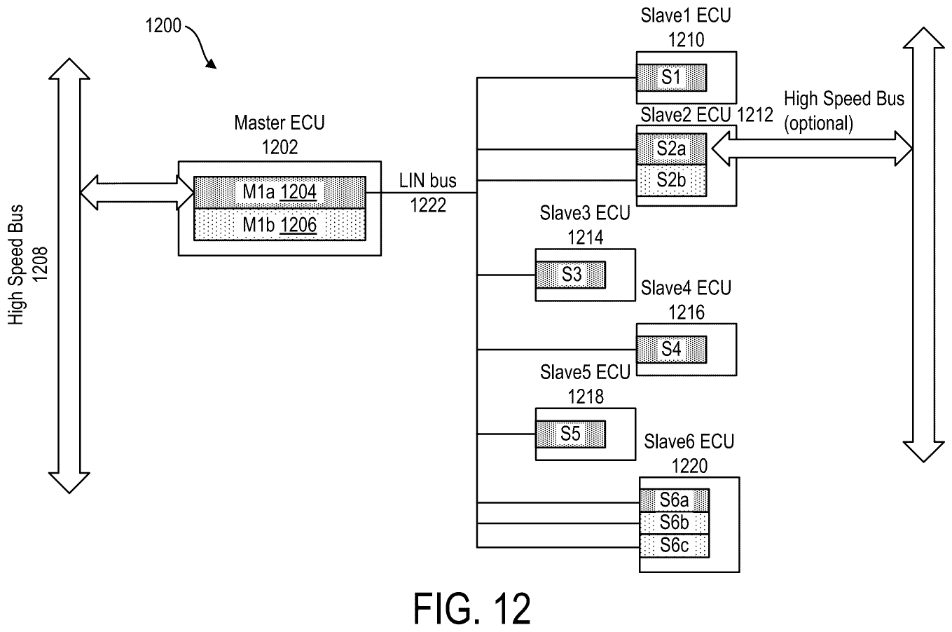

FIG. 12 shows a block diagram illustrating a dynamically reassigned and secured LIN 1200, according to one or more examples. A LIN master node M1a 1204 and a redundant LIN master node Mlb 1206 of a master ECU 1202, may manage network operations, including communication with LIN slave nodes and interfacing with a high-speed data bus 1208. The LIN may include several slave nodes, labeled as Slave1 ECU 1210, Slave2 ECU 1212, Slave3 ECU 1214, Slave4 ECU 1216, Slave5 ECU 1218, and Slave6 ECU 1220, connected to a LIN bus 1222. The LIN bus 1222 may act as a communication channel, enabling data exchange between the master and slave nodes.

Some slave nodes, such as the Slave2 ECU 1212 and the Slave6 ECU 1220, may include redundant nodes, represented by S2b, S6b, and S6c nodes. The S2b, S6b and S6c nodes may provide additional redundancy and flexibility, allowing the LIN 1200 to adapt in case of faults. If a fault is detected in the S2a node, the LIN master node M1a 1204 may reassign the LIN slave role in the Slave2 ECU 1212 from the S2a node to the S2b node. Similarly, if the fault is detected in the S6a node, the LIN master node M1a 1204 may reassign the LIN slave role in the Slave6 ECU 1220 from the S6a node to one of the S6b node or the S6c node. Moreover, the LIN may include AI nodes at edge of the LIN 1200 to redefine bus nodes to enhance data throughput and network performance.

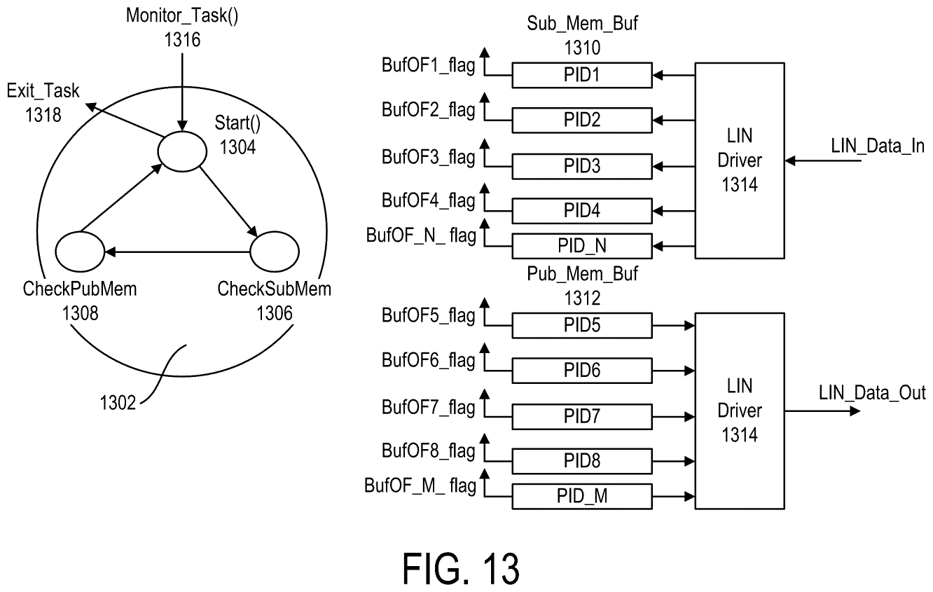

FIG. 13 shows a block diagram illustrating a LIN PID channel monitor, according to one or more examples. The LIN PID channel monitor may include a PID channel monitoring loop 1302 including three tasks. The three tasks may include Start( ) 1304, CheckSubMem 1306, and CheckPubMem 1308. The PID channel monitoring loop 1302 may be designed to continuously evaluate and manage data associated with subscribing and publishing PIDs within the LIN. The Start( ) task 1304 may initiate monitoring operation and set conditions for subsequent tasks. The Start( ) task 1304 may act as an entry point for the PID channel monitoring loop 1302, preparing the system 100 to check data flows in the memory buffers associated with the LIN PIDs.

The CheckSubMem 1306 task may monitor subscription memory buffers (Sub_Mem_Buf 1310) associated with incoming data PIDs (PID1 to PID_N). Each subscription memory buffer 1310 may be linked to a specific PID and is checked for buffer overflow flags (BufOF1_flag to BufOFN_flag). If a buffer overflow is detected, it may indicate that the incoming data exceeds a predefined capacity of the subscription memory buffer, triggering corrective actions to manage data flow and prevent data loss. The CheckPubMem 1308 may monitor the publication memory buffers (Pub_Mem_Buf 1312) linked to outgoing data PIDs (PID5 to PID_M). Each publication memory buffer may be linked to a specific PID and is checked for buffer overflow flags (BufOF5_flag to BufOFM_flag). If a buffer overflow is detected, it may indicate that the outgoing data exceeds a predetermined capacity of the publication memory buffer, triggering corrective actions to manage data flow and prevent data loss.

The LIN driver 1314 may act as an intermediary component, managing the data exchange between the memory buffers and the LIN bus. It may facilitate the routing of LIN data, such that the incoming data (LIN_Data_In) is directed to the subscription memory buffers and that outgoing data (LIN_Data_Out) is sourced from the publication memory buffers. A Monitor_Task( ) 1316 as depicted in the PID channel monitoring loop 1302, may maintain an active state of the PID channel monitoring loop 1302, while an Exit_Task( ) 1318 may facilitate controlled termination of the PID channel monitoring loop 1302.

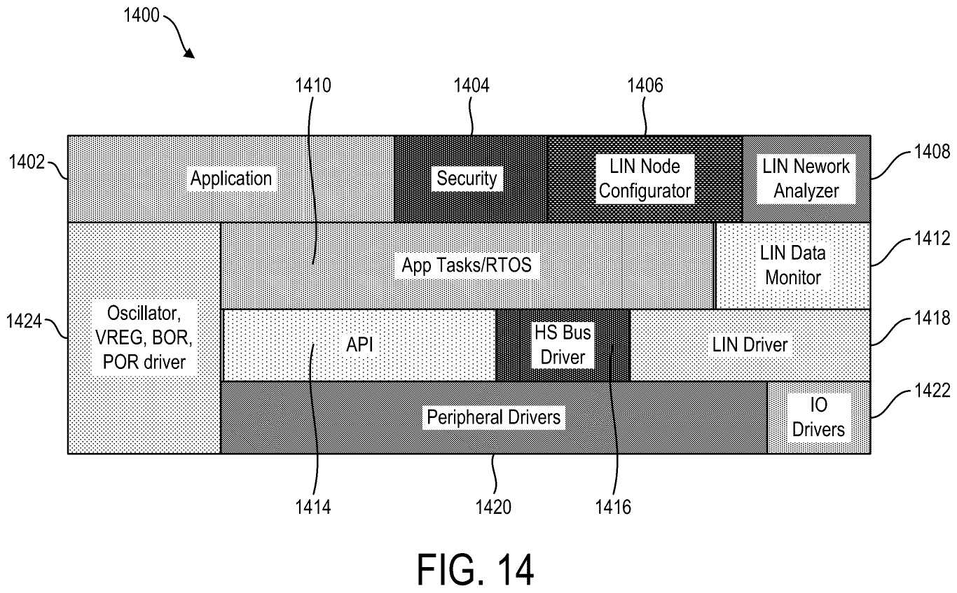

FIG. 14 shows a block diagram illustrating a LIN master firmware stack model 1400, according to one or more examples. The LIN master firmware stack model 1400 details a layered architecture of the LIN master node, outlining functional components and their interactions within the system 100.

The LIN master firmware stack model 1400 may include an application layer 1402 where user-specific applications are executed. The application layer 1402 may manage operational tasks of the LIN master node and interact with other layers, for efficient processing and control of the LIN. A security layer 1404 may provide data integrity and confidentiality within the LIN. The security layer 1404 may manage encryption and decryption operations and implement security protocols to safeguard communication against unauthorized access or data breaches.

A LIN node configurator 1406 may manage the configurations of the LIN nodes, to facilitate dynamic reassignment and updates of node configurations. The LIN node configurator 1406 may facilitate node role changes such that the correct settings are consistently applied across the LIN. A LIN network analyzer 1408 may monitor and analyze network traffic to detect potential faults. An app tasks/RTOS layer 1410 may manage real-time operating system (RTOS) tasks and application-specific processes. The LIN data monitor 1412 may monitor data transmission and reception, managing data flow, and ensuring the reliability of communication within the LIN network. The LIN data monitor 1412 may identify bottlenecks and facilitate data handling to prevent data loss or delays.

An API layer 1414 may provide interfaces for application development, enabling seamless interaction between software components and hardware components. A high-speed (HS) bus driver 1416 may facilitate communication between the LIN and high-speed backbone bus. The HS bus driver 1416 may facilitate efficient data transfer and coordination between different network segments, allowing for seamless integration and connectivity across the system 100.

The LIN driver 1418 may handle communication protocols and manage data exchange on the LIN bus. The LIN driver 1418 may process LIN frames and maintain synchronization across nodes. A peripheral drivers layer 1420 may interface with various hardware peripherals connected to the LIN master node. The peripheral drivers layer 1420 may manage input/output operations, sensor data acquisition, and actuator control, supporting the functionality of external components and devices. An IO drivers layer 1422 may provide control over input/output devices, ensuring accurate and efficient data exchange between the firmware and external components. A foundational layer 1424 may include drivers for oscillator, voltage regulation (VREG), brown-out reset (BOR), and power-on reset (POR), for stable operation and reliable system start-up.

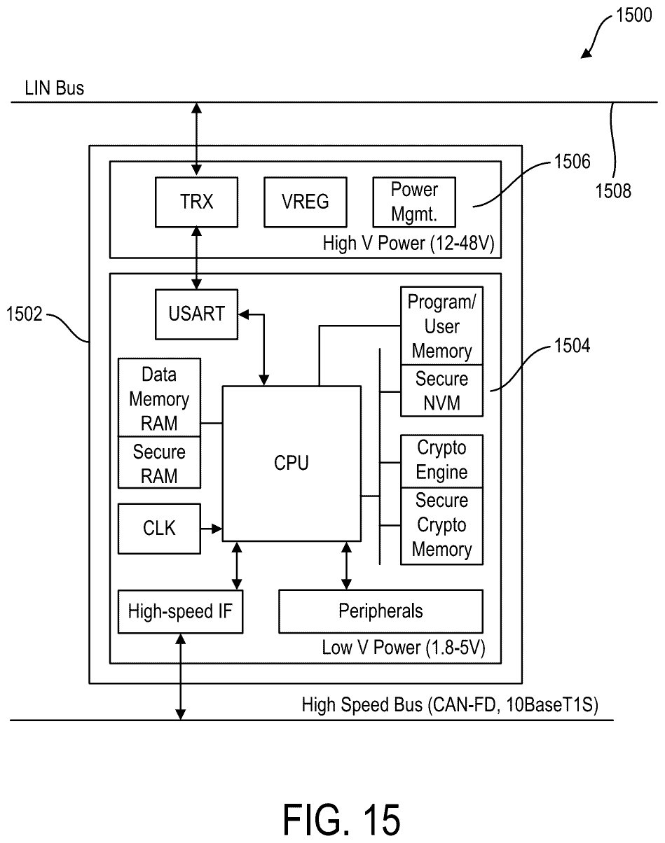

FIG. 15 shows a block diagram 1500 illustrating a LIN node 1502 with a HS interface, according to one or more examples. The LIN node 1502 may support dynamic reassignment and secure communication within the LIN, featuring low voltage 1504 and high voltage 1506 sections to cater to diverse operational conditions. When initially used as a LIN slave node, it can be reassigned as a LIN master node that requires the HS interface.

The low voltage section 1504 may include a central processing unit (CPU) to coordinate operations. The CPU may be operatively coupled with a program and data memories. The data memories may include a secure RAM and a secure NVM. The non-volatile memory may include encryption keys. The CPU may interact with application software and update a user memory, for the LIN node 1502 to adapt changing configurations or schedule tables.

The low voltage section 1504 may include a USART to facilitate serial communication for LIN transmissions, supporting interactions with a LIN bus 1508. The USART may operate alongside the HS interface to connect the LIN node 1502 to a central control unit or body control module (BCM), enabling nodes to operate as LIN masters and network gateways.

The low voltage section 1504 may include a crypto module for secure communications by providing encryption and decryption. The crypto module may utilize a secure crypto memory to store private keys, public keys and certificates, supporting asymmetric algorithms such as ECC or RSA and symmetric algorithms such as AES-128/256. The low voltage section 1504 may include a random number generator to send RND challenges for authenticating peer nodes on the LIN bus 1508 or high-speed networks.

The low voltage section 1504 may include peripheral interfaces such as sensors and custom interfaces to allow the LIN node 1502 to collect application-specific data, such as temperature readings or motor control inputs. The peripheral interfaces may support embedded functions and data acquisition. The low voltage section 1504 may include a clock to synchronize operations within the LIN node 1502, for timely execution of tasks and coordination with other components in the LIN.

The high voltage section 1506 may include a transceiver (TRX) to manage electrical communication with a high-voltage LIN bus, facilitating data exchange with other nodes. The high voltage section 1506 may include a voltage regulator (VREG) to handle power regulation and conversion, for a stable power supply for operations of the LIN node 1502. The high voltage section 1506 may include a power management and sense module.

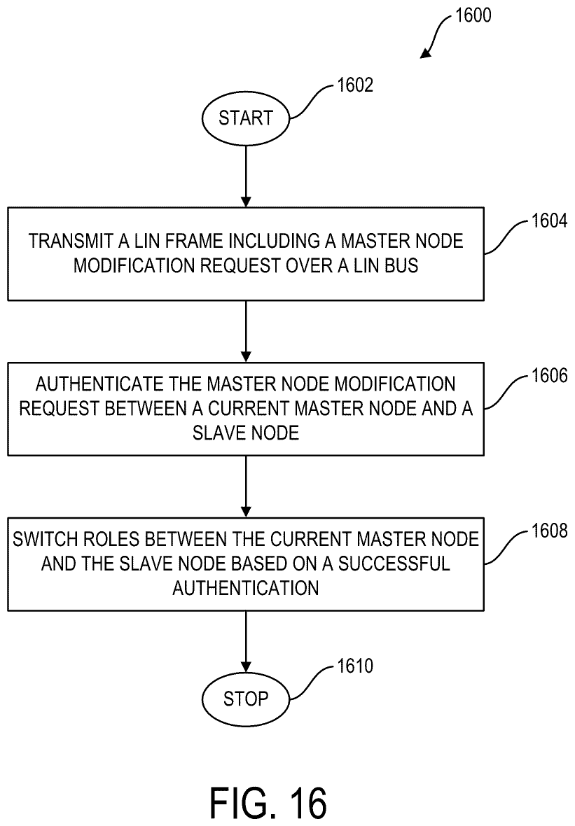

FIG. 16 shows a flowchart 1600 illustrating a method for dynamic reassignment of a master node in a LIN, according to one or more examples. It may be noted that in order to explain the method operations of the flowchart 1600, references will be made to the elements explained in FIG. 1.

The flowchart 1600 starts at operation 1602. At operation 1604, the method may include transmitting a LIN frame including a master node modification request over the LIN bus 102. At operation 1606, the method may include authenticating the master node modification request between the current master node 106 and a slave node. At operation 1608, the method may include switching roles between the current master node 106 and the slave node based on a successful authentication.

The flowchart 1600 terminates at operation 1610. It may be noted that the flowchart 1600 is explained to have above stated process operations; however, those skilled in the art would appreciate that the flowchart 1600 may have more/less number of process operations which may enable all the above stated examples of the present disclosure.

Various examples have been disclosed herein, in connection with the above description and the drawings. It will be understood that it would be unduly repetitious to literally describe and illustrate each combination and subcombination of these examples. Accordingly, all examples can be combined in any way or combination, and the present specification, including the drawings, shall be construed to constitute a complete written description of all combinations and subcombinations of these examples herein, and of the manner and process of making and using them, and shall support claims to any such combination or subcombination.

It will be appreciated by persons skilled in the art that the examples described herein are not limited to what has been particularly shown and described herein above. In addition, unless mention was made above to the contrary, it is noted that all of the accompanying drawings may not be to scale. A variety of modifications and variations are possible in light of the above teachings.

What is claimed is:

1. A method for dynamic reassignment of a master node in a Local Interconnect Network (LIN), comprising:
detecting a LIN frame comprising a master node modification request transmitted over a LIN bus;
authenticating the master node modification request between a current master node and a slave node; and
switching roles between the current master node and the slave node based on a successful authentication.

2. The method of claim 1, wherein the authenticating comprises:
sending, by the current master node, a first random number (RND) challenge to the slave node;
generating a first digest response by the slave node, in response to the first RND challenge, using a slave private cryptographic key stored in a memory;
sending, by the slave node, the first digest response to the current master node;
validating, by the current master node, the first digest response by:
encrypting the first RND challenge using a slave public cryptographic key stored in the memory to generate a first comparison digest response; and
comparing the first comparison digest response with the first digest response received from the slave node; and
authenticating the slave node if the first comparison digest response matches the first digest response.

3. The method of claim 2, wherein the authenticating further comprises:
sending, by the slave node, a second RND challenge to the current master node;
generating a second digest response by the current master node, in response to the second RND challenge, using a master private cryptographic key stored in the memory;
sending, by the current master node, the second digest response to the slave node;
validating, by the slave node, the second digest response by:
encrypting the second RND challenge using a master public cryptographic key stored in the memory to generate a second comparison digest response; and
comparing the second comparison digest response with the second digest response received from the current master node; and
authenticating the current master node if the second comparison digest response matches the second digest response.

4. The method of claim 1, comprising modifying LIN firmware configurations through the LIN bus to facilitate the dynamic reassignment of the master node, wherein the modifying comprises:
updating a first LIN software driver configuration on the current master node to reassign the role of the current master node to the slave node;
updating a second LIN software driver configuration on the slave node to reassign the role of the slave node to the current master node;
sending configuration commands over the LIN bus to update the LIN firmware configurations of the current master node and the slave node; and
executing the configuration commands to complete the dynamic reassignment operation.

5. The method of claim 4, comprising:
dynamically updating a schedule table of the LIN based on real-time monitoring of traffic patterns and network loading conditions; and
adjusting time slot assignments and inter-frame spacing within the schedule table to control bandwidth utilization of the LIN bus and data transmission efficiency based on the roles of the current master node and the slave node in the LIN.

6. The method of claim 1, comprising adjusting LIN hardware configurations through the LIN bus, wherein the adjusting comprises:
modifying pull-up resistor settings to change electrical characteristics of the current master node and the slave node; and
updating microcontroller configurations to support the roles of the nodes.

7. The method of claim 1, comprising:
monitoring, by the current master node and the slave node, the LIN bus for errors and throughput limitations; and
initiating the dynamic reassignment of the master node when a threshold for either the errors or the throughput limitations is reached.

8. A system for dynamic reassignment of a master node in a Local Interconnect Network (LIN), comprising:
a plurality of nodes, comprising a current master node and a slave node, each node of the plurality of nodes connected to a LIN bus;
a communication circuitry to transmit and receive LIN frames on the LIN bus; and
a processing circuitry to:
identify a LIN frame comprising a master node modification request over the LIN bus;
authenticate the master node modification request between the current master node and the slave node; and
switch roles between the current master node and the slave node based on a successful authentication.

9. The system of claim 8, further comprising a memory to store at least a slave private cryptographic key, a master private cryptographic key, a slave public cryptographic key, and a master public cryptographic key.

10. The system of claim 9, wherein the processing circuitry is to:
send a first random number (RND) challenge from the current master node to the slave node;
generate a first digest response at the slave node using the slave private cryptographic key, in response to the first RND challenge;
send the first digest response from the slave node to the current master node;
validate the first digest response at the current master node by:
encrypting the first RND challenge using the slave public cryptographic key to generate a first comparison digest response; and
comparing the first comparison digest response with the first digest response received from the slave node; and
authenticate the slave node if the first comparison digest response matches the first digest response.

11. The system of claim 10, wherein the processing circuitry is to:
send a second RND challenge from the slave node to the current master node;
generate a second digest response at the current master node using the master private cryptographic key, in response to the second RND challenge;
send the second digest response from the current master node to the slave node;
validate the second digest response at the slave node by:
encrypting the second RND challenge using the master public cryptographic key to generate a second comparison digest response; and
comparing the second comparison digest response with the second digest response received from the current master node; and
authenticate the current master node if the second comparison digest response matches the second digest response.

12. The system of claim 8, wherein the processing circuitry is to modify LIN firmware configurations by:
updating a first LIN software driver configuration on the current master node to reassign the role of the current master node to the slave node;
updating a second LIN software driver configuration on the slave node to reassign the role of the slave node to the current master node;
sending configuration commands over the LIN bus to update the LIN firmware configurations of the current master node and the slave node; and
executing the configuration commands to complete the dynamic reassignment operation.

13. The system of claim 8, wherein the processing circuitry is to:
dynamically update a schedule table of the LIN based on real-time monitoring of traffic patterns and network loading conditions; and
adjust time slot assignments and inter-frame spacing within the schedule table to control bandwidth utilization of the LIN bus and data transmission efficiency based on the roles of the current master node and the slave node in the LIN.

14. The system of claim 8, wherein the processing circuitry is to adjust LIN hardware configurations through the LIN bus by:
modifying pull-up resistor settings to change electrical characteristics of the current master node and the slave node; and
updating microcontroller configurations to support the roles of the nodes.

15. The system of claim 8, wherein the processing circuitry is to:
monitor the LIN bus for errors and throughput limitations; and
initiate the dynamic reassignment of the master node when a threshold for either the errors or the throughput limitations is reached.

16. A non-transitory computer-readable medium having instructions stored thereon that, when executed by at least one computing device, cause the at least one computing device to perform operations comprising:
detecting a Local Interconnect Network (LIN) frame comprising a master node modification request transmitted over a LIN bus;
authenticating the master node modification request between a current master node and a slave node; and
switching roles between the current master node and the slave node based on a successful authentication.

17. The non-transitory computer-readable medium of claim 16, wherein the authenticating operation comprises:
sending, by the current master node, a first random number (RND) challenge to the slave node;
generating a first digest response by the slave node, in response to the first RND challenge, using a slave private cryptographic key stored in a memory;
sending, by the slave node, the first digest response to the current master node;
validating, by the current master node, the first digest response by:
encrypting the first RND challenge using a slave public cryptographic key stored in the memory to generate a first comparison digest response; and
comparing the first comparison digest response with the first digest response received from the slave node; and
authenticating the slave node if the first comparison digest response matches the first digest response.

18. The non-transitory computer-readable medium of claim 17, wherein the authenticating operation further comprises:
sending, by the slave node, a second RND challenge to the current master node;
generating a second digest response by the current master node, in response to the second RND challenge, using a master private cryptographic key stored in the memory;
sending, by the current master node, the second digest response to the slave node;
validating, by the slave node, the second digest response by:
encrypting the second RND challenge using a master public cryptographic key stored in the memory to generate a second comparison digest response; and
comparing the second comparison digest response with the second digest response received from the current master node; and
authenticating the current master node if the second comparison digest response matches the second digest response.

19. The non-transitory computer-readable medium of claim 16, wherein the operations further comprise adjusting LIN hardware configurations through the LIN bus, wherein the adjusting comprising:
modifying pull-up resistor settings to change electrical characteristics of the current master node and the slave node; and
updating microcontroller configurations to support the roles of the nodes.

20. The non-transitory computer-readable medium of claim 16, wherein the operations further comprise:
monitoring, by the current master node and the slave node, the LIN bus for errors and throughput limitations; and
initiating the dynamic reassignment of the master node when a threshold for either the errors or the throughput limitations is reached.
